(19) United States
(12) Patent Application Publication
(10) Pub. No.: US 2017/0033927 A1
(43) Pub. Date: Feb. 2, 2017

(54) KEY OBFUSCATION

(71) Applicant: Hewlett-Packard Development Company, L.P., Houston, TX (US)

(72) Inventors: Chris A. WINDLE, Sunnyvale, CA (US); Vladimir Libershteyn, Sunnyvale, CA (US); Richard Liu, Sunnyvale, CA (US)

(21) Appl. No.: 14/815,659

(22) Filed: Jul. 31, 2015

(51) Int. Cl. H04L 9/08

(52) U.S. Cl. CPC H04L 9/0861; H04L 9/0819

(57) ABSTRACT

According to an example, key obfuscation may include forming a key by using parts.

### BACKGROUND

A key, such as a symmetric key, may be used to form a secure communication channel between two devices. The key may be stored in an obfuscated (i.e., obscured) format. For example, the key may be encrypted to prevent unauthorized use and/or access.

### BRIEF DESCRIPTION OF DRAWINGS

Features of the present disclosure are illustrated by way of example and not limited in the following figure(s), in which like numerals indicate like elements, in which:

FIG. 1 illustrates an architecture of a key obfuscation system, according to an example of the present disclosure;

FIG. 2 illustrates an eight bytes key obfuscation for the key obfuscation system of FIG. 1, according to an example of the present disclosure;

FIG. 3 illustrates a four bytes key obfuscation for the key obfuscation system of FIG. 1, according to an example of the present disclosure;

FIG. 4 illustrates a flowchart of a method for key obfuscation, according to an example of the present disclosure;

FIG. 5 illustrates a flowchart of the method for key obfuscation, according to an example of the present disclosure;

FIG. 6 illustrates a flowchart of the method for key obfuscation, according to an example of the present disclosure; and

FIG. 7 illustrates a computer system, according to an example of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

With respect to key obfuscation, a key may be stored on a secure device for implementing a secure communication channel with another device, such as, for example, a smart card. Although storing the key on the secure device may prevent unauthorized use and/or access to the key, in the event the secure device is compromised, the key may be likewise compromised.

In order to address this technical challenge related to key security, according to examples, a key obfuscation system and a method for key obfuscation system are disclosed herein. The example of the system and method disclosed herein may provide for key obfuscation based on division of a key into three logically related parts (e.g., RP1, RP2, and RP3), where each of the three parts is the same size as the key.

The division of a key into three logically related parts (e.g., RP1, RP2, and RP3) as disclosed herein may provide for a first level of defense against unauthorized use and/or access to a key, where the three parts may be stored at different locations of a device and/or by using multiple devices (e.g., a device per key part). Further, the division of the key into the three logically related parts as disclosed herein may provide for a second level of defense against unauthorized use and/or access to the key by obfuscating the key in a manner that is unknown to an unauthorized entity.

As disclosed herein, the three logically related parts may be designated as a mapping part (e.g., RP3), a first operative part (e.g., RP1), and a second operative part (e.g., RP2). When the key is to be formed, the three parts may be combined as disclosed herein, and a logical operation, such as, for example, an XOR operation may be used. Thus, the same key that is used to form the three parts based on a process to form the key as disclosed herein may be re-formed based on a reverse process using the three parts.

According to examples, in order to form the key, the mapping part (e.g., RP3) may be used to map a value of the first operative part (e.g., RP1) that the second operative part (e.g., RP2) is to be XOR'd with. According to examples, with respect to a hexadecimal key, the mapping part (e.g., RP3) may be used to map a nibble or byte of the first operative part (e.g., RP1) that the second operative part (e.g., RP2) is to be XOR'd with. That is, with respect to a hexadecimal key, the first operative part (e.g., RP1) may be XOR'd with a specific nibble or byte of the second operative part (e.g., RP2) and an index determined by a nibble or byte of the mapping part (e.g., RP3). Generally, the index determined by a value (e.g., nibble or byte for a hexadecimal key) of the mapping part (e.g., RP3) may represent a position of a value of the second operative part (e.g., RP2) that is to be XOR'd with a value of the first operative part (e.g., RP1).

In computing, a nibble that includes a standard size of four bits may represent one-half of a byte, with a range of 0-F, whereas a byte (i.e., eight bits) may include a range of 00-FF.

According to examples, the system and method disclosed herein may be used with keys of different sizes (e.g., one byte to seven bytes, eight bytes, twenty bytes, 256 bytes, and generally greater than one byte). For example, for the system and method disclosed herein, for an eight bytes key (i.e., including sixteen nibbles), with each nibble being used as an index, all sixteen nibbles may be indexed with 0-F. For example, 0x4C may include nibble values of 0x4 (four decimal) and 0xC (twelve decimal). For key sizes from nine bytes to 255 bytes, key segments of eight bytes (and a remaining key segment of one to seven bytes) may be concatenated together to form the overall key. For key sizes 256 bytes and larger, each byte may be used as an index, with all 256 bytes being indexed with 00-FF. Further, a one byte key may be indexed with 0-1, a two byte key may be indexed with 0-3, a five byte key may be indexed with 0-9, a six byte key may be indexed with 0-B, and a seven byte key may be indexed with 0-E.

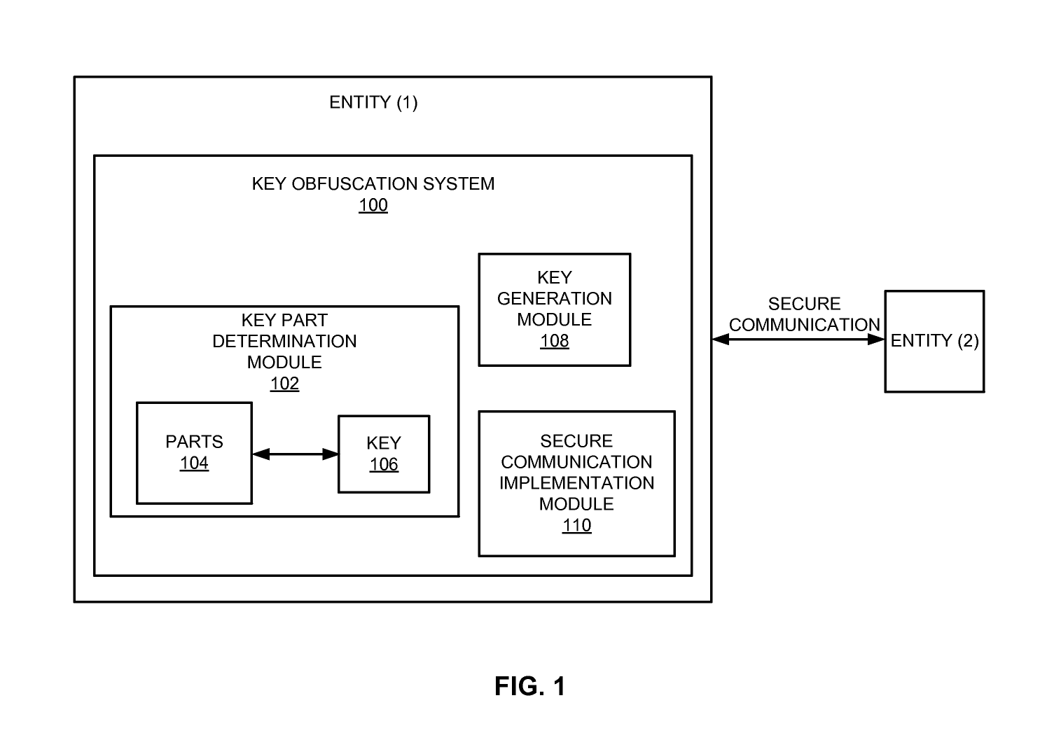

FIG. 1 illustrates an architecture of a key obfuscation system (hereinafter also referred to as “system 100”), according to an example of the present disclosure. Referring to FIG. 1, the system 100 is depicted as including a key part determination module 102 that is to generate parts 104 (e.g., designated RP1, RP2, and RP3) that are to be used to form a key 106. The key part determination module 102 may generate a mapping part (e.g., RP3) as a random permutation of values based on a size of the key 106. For example, if the key 106 includes eight bytes, the mapping part (e.g., RP3) may be generated as a random permutation of values 0-F. The key part determination module 102 may be disposed separately from the system 100, or provided as a component of the system 100 as illustrated in FIG. 1.

The key part determination module 102 may generate a first operative part (e.g., RP1) as the same size as the key 106, and to include random values. For example, if the key 106 includes eight bytes, the first operative part (e.g., RP1) may include any random values (e.g., any random values from 0-F, where the values may be repeated), and include the same size as the key 106.

The key part determination module 102 may apply a logical operation (e.g., an XOR operation) to each nibble of the key 106 with each corresponding nibble of the first operative part (e.g., RP1) to generate an intermediate part (e.g., XORP).

The key part determination module 102 may use the intermediate part (e.g., XORP) to generate a second operative part (e.g., RP2) by using the mapping part (e.g., RP3) as an index.

According to examples, with respect to using the intermediate part (e.g., XORP) to generate the second operative part (e.g., RP2) by using the mapping part (e.g., RP3) as the index, for the key 106 including one byte to eight bytes, the key part determination module 102 may move each nibble from the intermediate part (e.g., XORP) to the second operative part (e.g., RP2) by using corresponding nibbles from the mapping part (e.g., RP3) as the index. As disclosed herein, with respect to the key 106 including four bytes, the allowed nibble values for the index based on the mapping part (e.g., RP3) may be restricted to 0-7. Further, with respect to the key 106 including eight bytes, the allowed nibble values for the index based on the mapping part (e.g., RP3) may be restricted to 0-F. This is because a value greater than seven may index beyond the eighth nibble (i.e., in the fourth byte).

A key generation module 108 may ascertain the parts (e.g., RP1, RP2, and RP3) that are to be used to form the key 106. The key generation module 108 may generate the key 106 by using the mapping part (e.g., RP3) to map the first operative part (e.g., RP1) with the second operative part (e.g., RP2). Further, the key generation module 108 may apply the logical operation to the mapped first operative part (e.g., RP1) and the second operative part (e.g., RP2).

According to examples, as disclosed herein, the parts 104 may be designated as arrays. In this regard, the key generation module 108 may generate the key 106 as follows:

RP1[size], RP2[size], RP3[size]

KEY[size]

for (i; i<size; i++)

KEY[i]=RP1 [i]̂RP2[RP3[i]]

In this regard, the “size” may represent a size of the associated array. The mapping part (e.g., RP3) may map the value of the first operative part (e.g., RP1) that the second operative part (e.g., RP2) is to be XOR'd with (represented as “A”). That is, the first operative part (e.g., RP1) may be XOR'd with a specific value of the second operative part (e.g., RP2) at an index determined by the mapping part (e.g., RP3). In this regard, the value may be set at four bits (nibble), eight bits (byte), or another number of bits specified by the needs of a user.

According to examples, for the key 106 that includes one byte to eight bytes, the key generation module 108 may use the mapping part (e.g., RP3) to map nibbles of the first operative part (e.g., RP1) with nibble of the second operative part (e.g., RP2). Further, the key generation module 108 may apply the logical operation to the mapped nibble of the first operative part (e.g., RP1) and the second operative part (e.g., RP2). As disclosed herein, with respect to the key 106 including four bytes, the allowed nibble values for the index based on the mapping part (e.g., RP3) may be restricted to 0-7, and with respect to the key 106 including eight bytes, the allowed nibble values for the index based on the mapping part (e.g., RP3) may be restricted to 0-F.

According to examples, for the key 106 that includes greater than eight bytes (e.g., twenty bytes) and less than 255 bytes, the key generation module 108 may divide the key to include a key segment of eight bytes (e.g., two segments of eight bytes for the example of twenty bytes), and a key segment of four bytes (e.g., one segment of four bytes for the example of twenty bytes). For the four bytes and the eight bytes key segments, the key generation module 108 may use the mapping part (e.g., RP3) to map each nibble of the first operative part (e.g., RP1) with a corresponding nibble of the second operative part (e.g., RP2). Further, the key generation module 108 may apply the logical operation to the mapped nibbles of the first operative part (e.g., RP1) and the second operative part (e.g., RP2).

According to examples, for the key 106 that includes 256-bytes, the key generation module 108 may use the mapping part (e.g., RP3) to map each byte of the first operative part (e.g., RP1) with a corresponding byte of the second operative part (e.g., RP2). Further, the key generation module 108 may apply the logical operation to the mapped bytes of the first operative part (e.g., RP1) and the second operative part (e.g., RP2).

According to examples, the key generation module 108 may determine a number of bytes included in the key 106. The key generation module 108 may use, based on the determined number of bytes included in the key 106, the mapping part (e.g., RP3) to map each nibble or byte of the first operative part (e.g., RP1) with a corresponding nibble or byte of the second operative part (e.g., RP2). Further, the key generation module 108 may apply the logical operation to the mapped nibbles or bytes of the first operative part (e.g., RP1) and the second operative part (e.g., RP2).

According to examples, a secure communication implementation module 110 may use the key 106 for a secure communication session, for example, between two entities (e.g., entity (1), and entity (2), as illustrated in FIG. 1). In this regard, the secure communication session may be created by using the key 106 to exchange a dynamically created symmetric key, and the two entities may use the dynamically created symmetric key to communicate. The entities may include any types of devices, networks, and generally, anything that may communicate using a secure communication session. According to examples, the entities may include a device that includes the system 100 implemented thereon for generating the key 106 from the key parts (e.g., RP1, RP2, and RP3), and a smart card. For the example of the smart card, the smart card may include a key (identical to the key 106) stored thereon. When the device that includes the system 100 implemented thereon is powered on or otherwise actuated, the key generation module 108 may generate the key 106 to initiate the secure communication session between the device that includes the system 100 implemented thereon and the smart card. Otherwise, when the device that includes the system 100 implemented thereon is powered off or otherwise not-actuated, the key 106 may be stored, for example, in a secure location on the device that includes the system 100 implemented thereon as the key parts (e.g., RP1, RP2, and RP3).

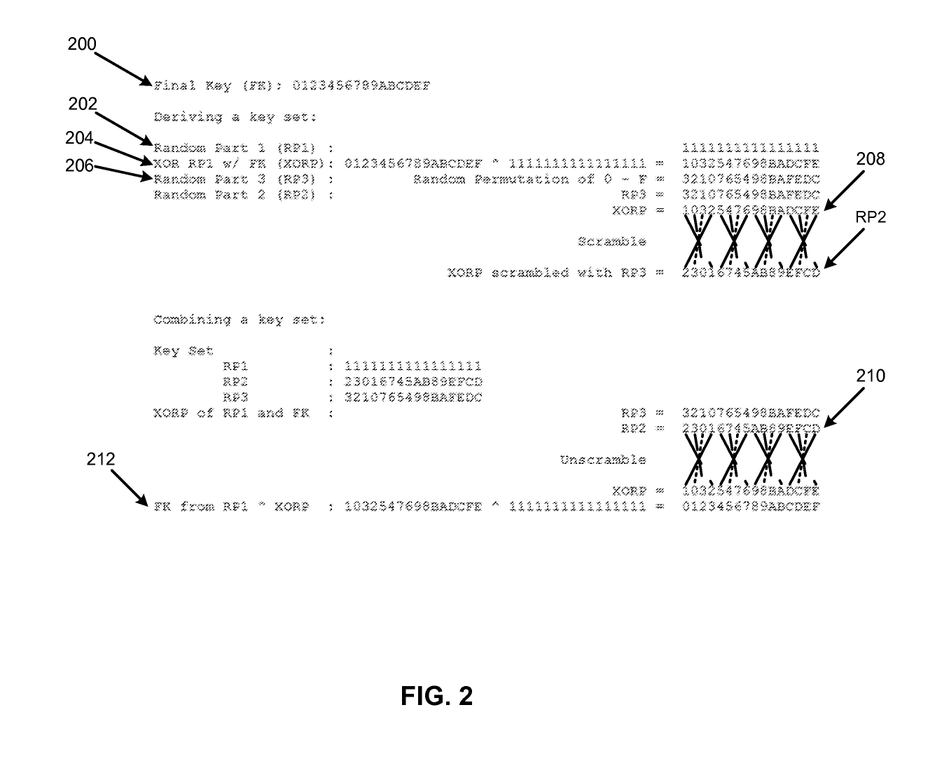

FIG. 2 illustrates an eight bytes key obfuscation for the key obfuscation system of FIG. 1, according to an example of the present disclosure.

According to examples, for the key 106 that is eight bytes long, the key part determination module 102 may divide the key 106 into three parts RP1, RP2, and RP3. For example, assuming that the key 106 at 200 is defined as FK(8)=0123456789ABCDEF, in order to obfuscate FK(8), the key part determination module 102 may generate a random eight bytes value for RP1 at 202 (e.g., RP1=1111111111111111).

At 204, the key part determination module 102 may XOR (shown as A) each nibble of FK(8) with the corresponding nibble of RP1 to generate XORP=0123456789ABCDEF̂1111111111111111=1032547698BADCFE.

At 206, the key part determination module 102 may generate a random permutation of the values 0-F (i.e., each value is used once) for RP3=3210765498 BAFEDC.

At 208, the key part determination module 102 may take each nibble from XORP and move it to RP2, using the nibble (i.e., four bits) from RP3 as an index. For example, for XORP nibble #0=1, this nibble for XORP may be shifted into RP2 in the nibble specified by RP3 nibble #0=3, resulting in RP2=XXX1XXXXXXXXXXXX.

Next, for XORP nibble #1=0, this nibble for XORP may be shifted into RP2 in the nibble specified by RP3 nibble #1=2, resulting in RP2=XX01XXXXXXXXXXXX.

Next, for XORP nibble #2=3, this nibble for XORP may be shifted into RP2 in the nibble specified by RP3 nibble #2=1, resulting in RP2=X301 XXXXXXXXXXXX.

Next, for XORP nibble #3=2, this nibble for XORP may be shifted into RP2 in the nibble specified by RP3 nibble #3=0, resulting in RP2=2301XXXXXXXXXXXX.

Next, for XORP nibble #4=5, this nibble for XORP may be shifted into RP2 in the nibble specified by RP3 nibble #4=7, resulting in RP2=2301XXX5XXXXXXXX.

Next, for XORP nibble #5=4, this nibble for XORP may be shifted into RP2 in the nibble specified by RP3 nibble #5=6, resulting in RP2=2301XX45XXXXXXXX.

In this manner, the remaining nibbles for XORP may be shifted into RP2 in the nibble specified by the corresponding RP3 nibble, resulting in RP2=23016745AB89EFCD.

The key part determination module 102 may retain RP1, RP2, and RP3, and discard XORP.

In order to generate the original key FK(8), the key generation module 108 may receive (and/or analyze) RP1, RP2, and RP3, and combine RP1, RP2, and RP3 to generate the original key FK(8). For example, at 210, the key generation module 108 may take each nibble from RP2, and move the nibble to XORP, using the nibble from RP3 as an index. For example, as shown at 210, RP3 nibble #0=3, and therefore RP2 nibble #3=1, which may be shifted into XORP nibble #0, resulting in XORP=1XXXXXXXXXXXXXXX.

Next for RP3 nibble #1=2, RP2 nibble #2=0 and this nibble for RP2 may be shifted into XORP nibble #1, resulting in XORP=10XXXXXXXXXXXXXX.

Next for RP3 nibble #2=1, RP2 nibble #1=3 and this nibble for RP2 may be shifted into XORP nibble #2, resulting in XORP=103XXXXXXXXXXXXX.

Next for RP3 nibble #3=0, RP2 nibble #0=2 and this nibble for RP2 may be shifted into XORP nibble #3, resulting in XORP=1032XXXXXXXXXXXX.

Next for RP3 nibble #4=7, RP2 nibble #7=5 and this nibble for RP2 may be shifted into XORP nibble #4, resulting in XORP=10325XXXXXXXXXXX.

In this manner, the remaining nibbles for RP2 may be shifted into the corresponding XORP nibble, resulting in XORP=1032547698BADCFE.

At 212, the key generation module 108 may use the XORP, and XOR each nibble of RP1 with the corresponding nibble from XORP to generate the final key FK(8)=1032547698BADCFÊ1111111111111111=0123456789ABCDEF.

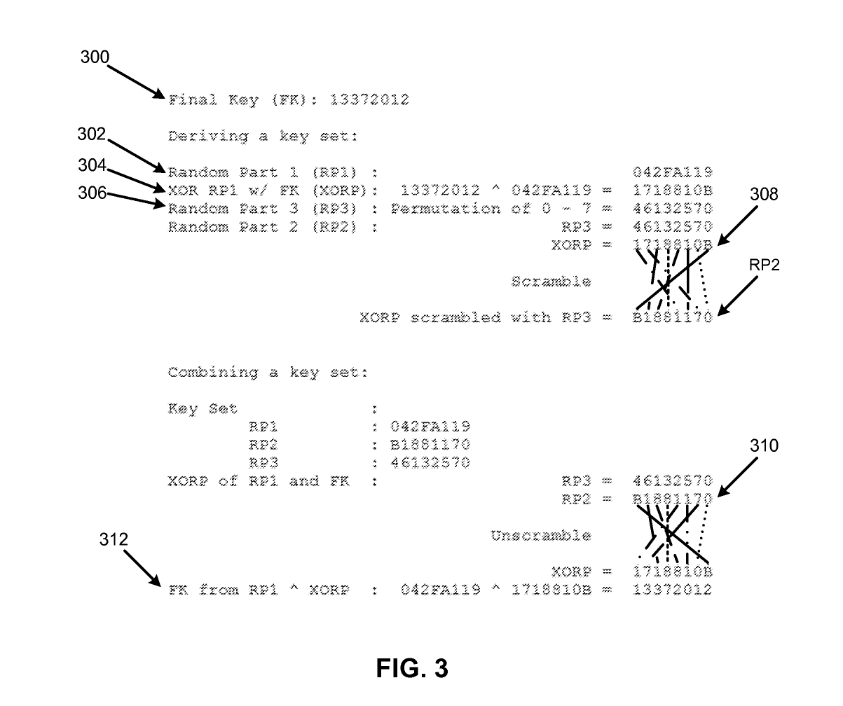

FIG. 3 illustrates a four bytes key obfuscation for the key obfuscation system of FIG. 1, according to an example of the present disclosure.

As disclosed herein, the example of the four bytes key may be applied to keys that are also greater than eight bytes. For example, for a twenty bytes key, such a key may be divided into two eight bytes keys, and one four bytes key for obfuscation. According to another example, for a twenty-eight bytes key, such a key may be divided into three eight bytes keys, and one four bytes key for obfuscation, and so forth for keys that are also greater than eight bytes.

According to examples, for the key 106 that is four bytes long, the key part determination module 102 may divide the key 106 into three parts RP1, RP2, and RP3. For example, assuming that the key 106 at 300 is defined as FK(4)=13372012, in order to obfuscate FK(4), the key part determination module 102 may generate a random four bytes value for RP1 at 302 (e.g., RP1=042FA119).

At 304, the key part determination module 102 may XOR each nibble of FK(4) with the corresponding nibble of RP1 to generate XORP=13372012̂042FA119=1718810B.

At 306, the key part determination module 102 may generate a random permutation of the values 0-7 (i.e., each value is used once) for RP3=46132570.

At 308, the key part determination module 102 may take each nibble from XORP and move it to RP2, using the corresponding nibble from RP3 as an index. For example, for XORP nibble #0=1, this nibble for XORP may be shifted into RP2 in the nibble specified by RP3 nibble #0=4, resulting in RP2=XXXX1XXX.

Next, for XORP nibble #1=7, this nibble for XORP may be shifted into RP2 in the nibble specified by RP3 nibble #1=6, resulting in RP2=XXXX1X7X.

Next, for XORP nibble #2=1, this nibble for XORP may be shifted into RP2 in the nibble specified by RP3 nibble #2=1, resulting in RP2=X1XX1X7X.

In this manner, RP2 may be determined as B1881170.

In order to generate the original key FK(4), the key generation module 108 may receive (and/or analyze) RP1, RP2, and RP3, and combine RP1, RP2, and RP3 to generate the original key FK(4) in a similar manner as described herein for FK(8) of FIG. 2. For example, at 310, the key generation module 108 may take each nibble from RP2, and move the nibble to XORP, using the nibble from RP3 as an index. In this manner, the original key FK(4) may be generated at 312.

According to examples, as disclosed herein, the system and method disclosed herein may be expanded for larger blocks of data (e.g., compared to eight bytes). For example, with respect to obfuscation of a key that includes 256 bytes into three parts (e.g., RP1, RP2, and RP3), with respect to the eight bytes obfuscation, instead of using a nibble for the index in RP3, an entire byte (i.e., 2 nibbles) may be used for the index. For the example of the 256 bytes key, RP1 may include 256 bytes, and RP3 may include a random permutation of 00-FF. The 256-bytes of data may then be XOR'd with RP1 (e.g., in a similar manner as at 204 of FIG. 2), and the results may be obfuscated using the index values specified in RP3 to determine RP2 (e.g., in a similar manner as at 208 of FIG. 2). This 256-bytes obfuscation process may be repeated for any size data (e.g., key 106) by utilizing 256-bytes chunks. For any remainder, the random permutation may be limited to the number of remaining bytes, i.e., from 0 to (N−1).

The modules and other elements of the system 100 may be machine readable instructions stored on a non-transitory computer readable medium. In this regard, the system 100 may include or be a non-transitory computer readable medium. In addition, or alternatively, the modules and other elements of the system 100 may be hardware or a combination of machine readable instructions and hardware.

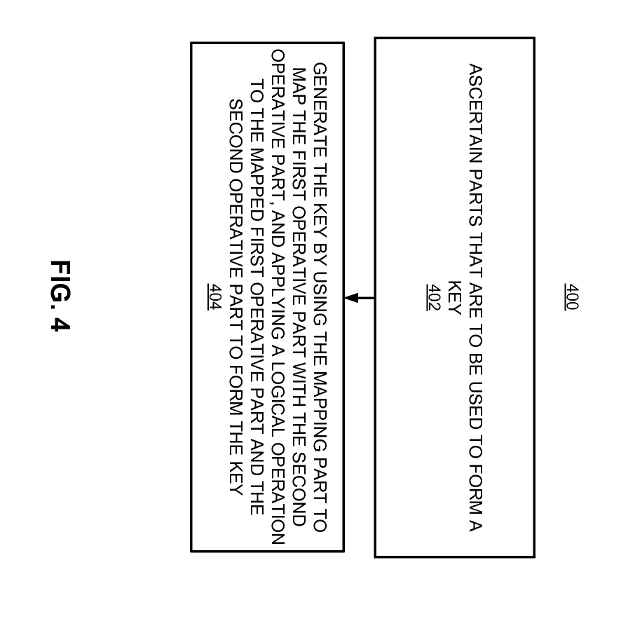

FIGS. 4-6 respectively illustrate flowcharts of methods 400, 500, and 600 for key obfuscation, corresponding to the example of the key obfuscation system 100 whose construction is described in detail above. The methods 400, 500, and 600 may be implemented on the key obfuscation system 100 with reference to FIGS. 1-3 by way of example and not limitation. The methods 400, 500, and 600 may be practiced in other systems.

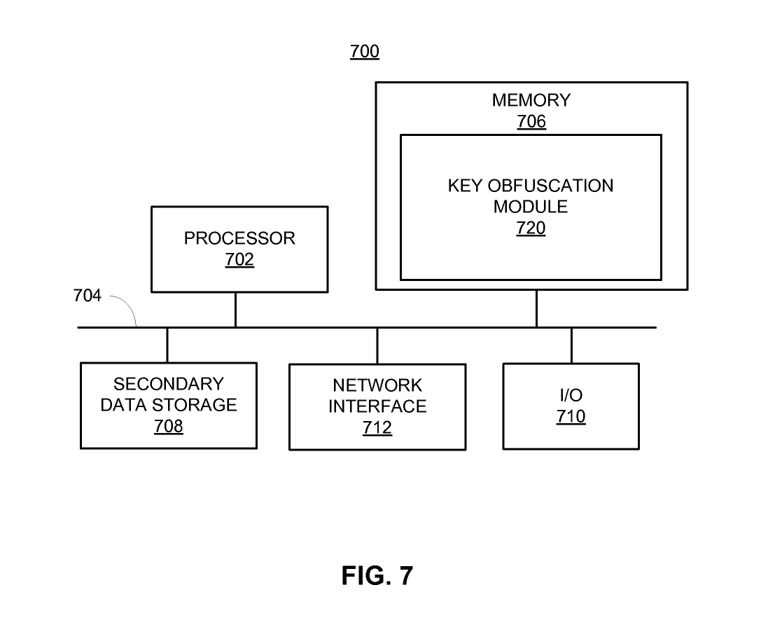

Further, although execution of the methods described herein is with reference to the system 100 of FIG. 1, other suitable devices for execution of these methods will be apparent to those of skill in the art. The methods described in the flowcharts of FIG. 4-6 may be implemented in the form of executable instructions stored on a machine-readable storage medium, such as the memory 706 and/or the secondary data storage 708 of FIG. 7, by one or more modules described herein, and/or in the form of electronic circuitry.

Referring to FIG. 4, for the method 400, at block 402, the method may include ascertaining parts that are to be used to form a key 106, where the parts may include a mapping part (e.g., RP3), and first and second operative parts (e.g., RP1 and RP2).

At block 404, the method 400 may include generating, by the computer system comprising the physical processor, the key 106 by using the mapping part (e.g., RP3) to map the first operative part (e.g., RP1) with the second operative part (e.g., RP2), and applying a logical operation to the mapped first operative part (e.g., RP1) and the second operative part (e.g., RP2) to form the key 106.

According to examples, for the method 400, the logical operation may include an XOR operation.

According to examples, the method 400 may include generating, by the computer system comprising the physical processor, the key 106 by using the mapping part (e.g., RP3) to map each nibble of the first operative part (e.g., RP1) with a corresponding nibble of the second operative part (e.g., RP2), and applying the logical operation that includes an XOR operation to the mapped nibbles of the first operative part (e.g., RP1) and the second operative part (e.g., RP2) to form the key 106.

According to examples, the method 400 may include applying the logical operation that includes the XOR operation to the mapped nibbles of the first operative part (e.g., RP1) and the second operative part (e.g., RP2) to form the key 106 by applying the logical operation that includes the XOR operation to the mapped nibbles of the first operative part (e.g., RP1) and the second operative part (e.g., RP2) to form the key 106 that includes one byte to eight bytes.

According to examples, the key 106 may include greater than eight bytes, and the method 400 may include generating, by the computer system comprising the physical processor, the key 106 by dividing the key 106 to include a key segment of eight bytes, and a key segment of one byte to seven bytes, and for each of the key segments using the mapping part (e.g., RP3) to map each nibble of the first operative part (e.g., RP1) with a corresponding nibble of the second operative part (e.g., RP2), and applying the logical operation that includes an XOR operation to the mapped nibbles of the first operative part (e.g., RP1) and the second operative part (e.g., RP2) to form the key 106.

According to examples, the method 400 may include generating, by the computer system comprising the physical processor, the key 106 by using the mapping part (e.g., RP3) to map each byte of the first operative part (e.g., RP1) with a corresponding byte of the second operative part (e.g., RP2), and applying the logical operation that includes an XOR operation to the mapped bytes of the first operative part (e.g., RP1) and the second operative part (e.g., RP2) to form the key 106.

According to examples, the method 400 may include generating, by the computer system comprising the physical processor, the key 106 by using the mapping part (e.g., RP3) to map each value of the first operative part (e.g., RP1) with a corresponding value of the second operative part (e.g., RP2), and applying the logical operation that includes an XOR operation to the mapped values of the first operative part (e.g., RP1) and the second operative part (e.g., RP2) to form the key 106.

According to examples, the method 400 may include generating, by the computer system comprising the physical processor, the parts that are to be used to form the key 106 by generating the first operative part (e.g., RP1) as a same size as the key 106, and to include random values, and applying the logical operation that includes an XOR operation to each nibble of the key 106 with each corresponding nibble of the first operative part (e.g., RP1) to generate an intermediate part. Further, the method 400 may include generating the mapping part (e.g., RP3) as a random permutation of values based on the size of the key 106, and using the intermediate part to generate the second operative part (e.g., RP2) by using the mapping part (e.g., RP3) as an index.

According to examples, for the key 106 including one byte to eight bytes, the method 400 may include using the intermediate part to generate the second operative part (e.g., RP2) by using the mapping part (e.g., RP3) as the index by moving each nibble from the intermediate part to the second operative part (e.g., RP2) by using corresponding nibbles from the mapping part (e.g., RP3) as the index.

According to examples, for the key 106 including two hundred fifty six bytes, the method 400 may include using the intermediate part to generate the second operative part (e.g., RP2) by using the mapping part (e.g., RP3) as the index by moving each byte from the intermediate part to the second operative part (e.g., RP2) by using corresponding bytes from the mapping part (e.g., RP3) as the index.

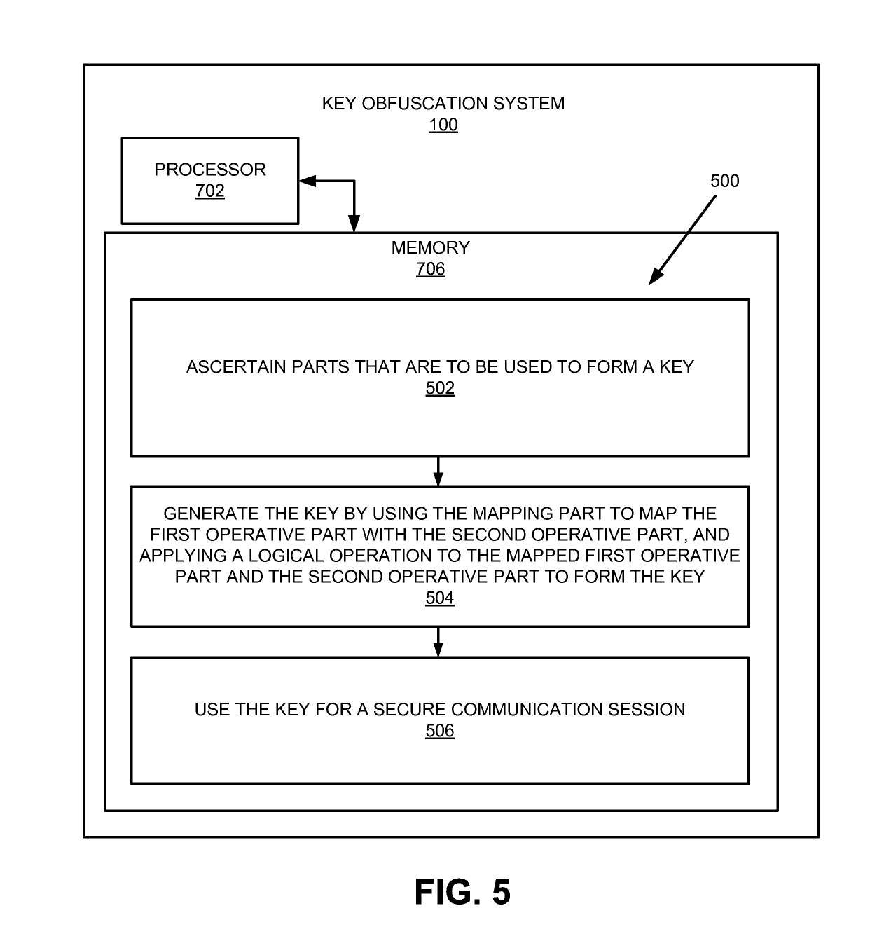

Referring to FIG. 5, for the method 500, at block 502, the method may include ascertaining parts that are to be used to form a key 106, where the parts may include a mapping part (e.g., RP3), and first and second operative parts (e.g., RP1 and RP2).

At block 504, the method may include generating the key 106 by using the mapping part (e.g., RP3) to map the first operative part (e.g., RP1) with the second operative part (e.g., RP2), and applying a logical operation to the mapped first operative part (e.g., RP1) and the second operative part (e.g., RP2) to form the key 106.

At block 506, the method may include using the key 106 for a secure communication session.

According to examples, the method 500 may include determining a number of bytes included in the key 106, using, based on the determined number of bytes included in the key 106, the mapping part (e.g., RP3) to map each nibble or byte of the first operative part (e.g., RP1) with a corresponding nibble or byte of the second operative part (e.g., RP2), and applying the logical operation that includes an XOR operation to the mapped nibbles or bytes of the first operative part (e.g., RP1) and the second operative part (e.g., RP2) to form the key 106.

According to examples, for the key 106 that includes greater than eight bytes, the method 500 may include generating the key 106 by dividing the key 106 to include a key segment of eight bytes, and a key segment of one byte to seven bytes, and for each of the key segments using the mapping part (e.g., RP3) to map each nibble of the first operative part (e.g., RP1) with a corresponding nibble of the second operative part (e.g., RP2), and applying the logical operation that includes an XOR operation to the mapped nibbles of the first operative part (e.g., RP1) and the second operative part (e.g., RP2) to form the key 106.

According to examples, for the key 106 that includes two hundred fifty six bytes, the method 500 may include generating the key 106 by using the mapping part (e.g., RP3) to map each byte of the first operative part (e.g., RP1) with a corresponding byte of the second operative part (e.g., RP2), and applying the logical operation that includes an XOR operation to the mapped bytes of the first operative part (e.g., RP1) and the second operative part (e.g., RP2) to form the key 106.

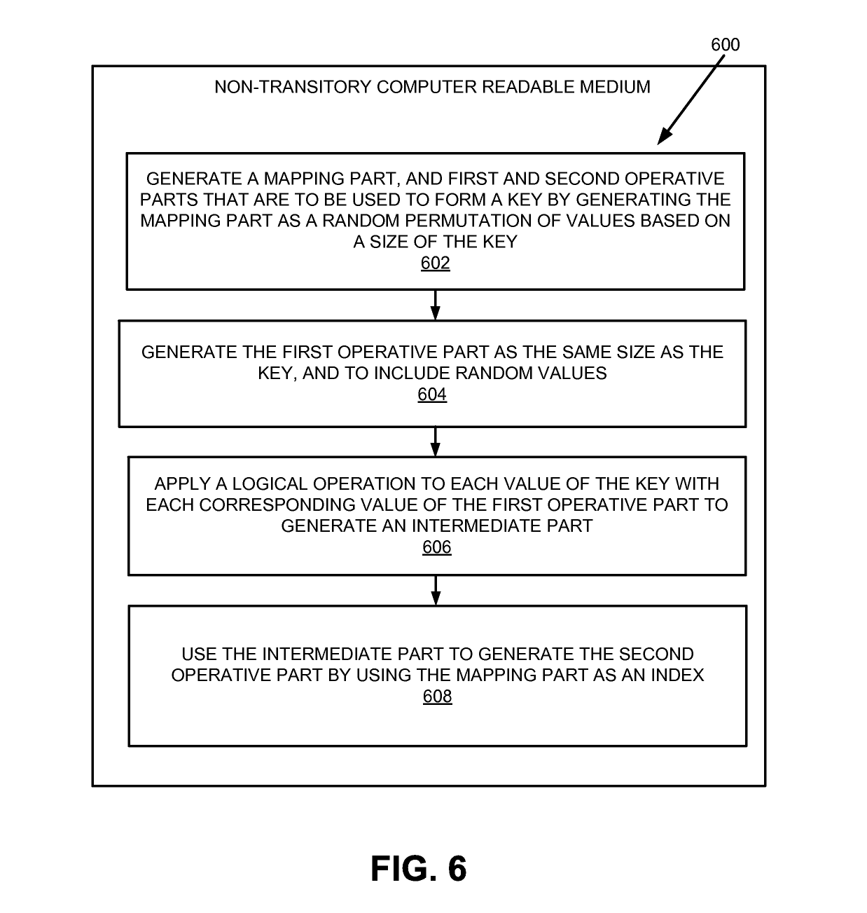

Referring to FIG. 6, for the method 600, at block 602, the method may include generating a mapping part (e.g., RP3), and first and second operative parts (e.g., RP1 and RP2) that are to be used to form a key 106 by generating the mapping part (e.g., RP3) as a random permutation of values based on a size of the key 106.

At block 604, the method may include generating the first operative part (e.g., RP1) as the same size as the key 106, and to include random values.

At block 606, the method may include applying a logical operation to each value of the key 106 with each corresponding value of the first operative part (e.g., RP1) to generate an intermediate part.

At block 608, the method may include using the intermediate part to generate the second operative part (e.g., RP2) by using the mapping part (e.g., RP3) as an index.

FIG. 7 shows a computer system 700 that may be used with the examples described herein. The computer system 700 may represent a generic platform that includes components that may be in a server or another computer system. The computer system 700 may be used as a platform for the system 100. The computer system 700 may execute, by a processor (e.g., a single or multiple processors) or other hardware processing circuit, the methods, functions and other processes described herein. These methods, functions and other processes may be embodied as machine readable instructions stored on a computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory).

The computer system 700 may include a processor 702 that may implement or execute machine readable instructions performing some or all of the methods, functions and other processes described herein. Commands and data from the processor 702 may be communicated over a communication bus 704. The computer system may also include a main memory 706, such as a random access memory (RAM), where the machine readable instructions and data for the processor 702 may reside during runtime, and a secondary data storage 708, which may be non-volatile and stores machine readable instructions and data. The memory and data storage are examples of computer readable mediums. The memory 706 may include a key obfuscation module 720 including machine readable instructions residing in the memory 706 during runtime and executed by the processor 702. The key obfuscation module 720 may include the modules of the system 100 shown in FIG. 1.

The computer system 700 may include an I/O device 710, such as a keyboard, a mouse, a display, etc. The computer system may include a network interface 712 for connecting to a network. Other known electronic components may be added or substituted in the computer system.

The foregoing disclosure describes a number of examples for key obfuscation. The disclosed examples may include systems, devices, computer-readable storage media, and methods for key obfuscation. For purposes of explanation, certain examples are described with reference to the components illustrated in FIGS. 1-7. The functionality of the illustrated components may overlap, however, and may be present in a fewer or greater number of elements and components. Further, all or part of the functionality of illustrated elements may co-exist or be distributed among several geographically dispersed locations. Moreover, the disclosed examples may be implemented in various environments and are not limited to the illustrated examples.

Further, the sequence of operations described in connection with FIGS. 1-7 are examples and are not intended to be limiting. Additional or fewer operations or combinations of operations may be used or may vary without departing from the scope of the disclosed examples. Furthermore, implementations consistent with the disclosed examples need not perform the sequence of operations in any particular order. Thus, the present disclosure merely sets forth possible examples of implementations, and many variations and modifications may be made to the described examples. All such modifications and variations are intended to be included within the scope of this disclosure and protected by the following claims.

What is claimed is:

1. A method for key obfuscation, the method comprising:
ascertaining, by a computer system comprising a physical processor, parts that are to be used to form a key, wherein the parts include a mapping part, and first and second operative parts; and
generating, by the computer system comprising the physical processor, the key by
using the mapping part to map the first operative part with the second operative part, and
applying a logical operation to the mapped first operative part and the second operative part to form the key.

2. The method according to claim 1, wherein the logical operation includes an XOR operation.

3. The method according to claim 1, wherein generating, by the computer system comprising the physical processor, the key further comprises:
using the mapping part to map each nibble of the first operative part with a corresponding nibble of the second operative part, and
applying the logical operation that includes an XOR operation to the mapped nibbles of the first operative part and the second operative part to form the key.

4. The method according to claim 3, wherein applying the logical operation that includes the XOR operation to the mapped nibbles of the first operative part and the second operative part to form the key further comprises:
applying the logical operation that includes the XOR operation to the mapped nibbles of the first operative part and the second operative part to form the key that includes one byte to eight bytes.

5. The method according to claim 1, wherein the key includes greater than eight bytes, and wherein generating, by the computer system comprising the physical processor, the key further comprises:
dividing the key to include a key segment of eight bytes, and a key segment of one byte to seven bytes; and
for each of the key segments
using the mapping part to map each nibble of the first operative part with a corresponding nibble of the second operative part, and
applying the logical operation that includes an XOR operation to the mapped nibbles of the first operative part and the second operative part to form the key.

6. The method according to claim 1, wherein generating, by the computer system comprising the physical processor, the key further comprises:
using the mapping part to map each byte of the first operative part with a corresponding byte of the second operative part, and
applying the logical operation that includes an XOR operation to the mapped bytes of the first operative part and the second operative part to form the key.

7. The method according to claim 1, wherein generating, by the computer system comprising the physical processor, the key further comprises:
using the mapping part to map each value of the first operative part with a corresponding value of the second operative part, and
applying the logical operation that includes an XOR operation to the mapped values of the first operative part and the second operative part to form the key.

8. The method according to claim 1, further comprising:
generating, by the computer system comprising the physical processor, the parts that are to be used to form the key by:
generating the first operative part
as a same size as the key, and
to include random values;
applying the logical operation that includes an XOR operation to each nibble of the key with each corresponding nibble of the first operative part to generate an intermediate part;
generating the mapping part as a random permutation of values based on the size of the key; and
using the intermediate part to generate the second operative part by using the mapping part as an index.

9. The method according to claim 8, wherein using the intermediate part to generate the second operative part by using the mapping part as the index further comprises:
for the key including one byte to eight bytes, moving each nibble from the intermediate part to the second operative part by using corresponding nibbles from the mapping part as the index.

10. The method according to claim 8, wherein using the intermediate part to generate the second operative part by using the mapping part as the index further comprises:
for the key including two hundred fifty six bytes, moving each byte from the intermediate part to the second operative part by using corresponding bytes from the mapping part as the index.

11. A key obfuscation system comprising:
at least one processor; and
a memory storing machine readable instructions that when executed by the at least one processor cause the at least one processor to:
ascertain parts that are to be used to form a key, wherein the parts include a mapping part, and first and second operative parts;
generate the key by
using the mapping part to map the first operative part with the second operative part, and
applying a logical operation to the mapped first operative part and the second operative part to form the key; and
use the key for a secure communication session.

12. The key obfuscation system according to claim 11, further comprising machine readable instructions to:
determine a number of bytes included in the key;
use, based on the determined number of bytes included in the key, the mapping part to map each nibble or byte of the first operative part with a corresponding nibble or byte of the second operative part; and
apply the logical operation that includes an XOR operation to the mapped nibbles or bytes of the first operative part and the second operative part to form the key.

13. The key obfuscation system according to claim 11, wherein the key includes greater than eight bytes, and wherein the machine readable instructions to generate the key further comprise instructions to:
divide the key to include a key segment of eight bytes, and a key segment of one byte to seven bytes; and
for each of the key segments
use the mapping part to map each nibble of the first operative part with a corresponding nibble of the second operative part, and
apply the logical operation that includes an XOR operation to the mapped nibbles of the first operative part and the second operative part to form the key.

14. The key obfuscation system according to claim 11, wherein the key includes two hundred fifty six bytes, and wherein the machine readable instructions to generate the key further comprise instructions to:
use the mapping part to map each byte of the first operative part with a corresponding byte of the second operative part, and
apply the logical operation that includes an XOR operation to the mapped bytes of the first operative part and the second operative part to form the key.

15. A non-transitory computer readable medium having stored thereon machine readable instructions to provide key obfuscation, the machine readable instructions, when executed, cause at least one processor to:
generate a mapping part, and first and second operative parts that are to be used to form a key by:
generating the mapping part as a random permutation of values based on a size of the key;
generating the first operative part
as the same size as the key, and
to include random values;
applying a logical operation to each value of the key with each corresponding value of the first operative part to generate an intermediate part; and
using the intermediate part to generate the second operative part by using the mapping part as an index.
